(19) United States
(12) Patent Application Publication
(10) Pub. No.: US 2005/0128072 A1
(43) Pub. Date: Jun. 16, 2005

(54) Security system for a building

(76) Inventor: Shih Hsiung Li, Taipei (TW)

Correspondence Address: BACON & THOMAS, PLLC, 625 SLATERS LANE, FOURTH FLOOR, ALEXANDRIA, VA, 22314, US

(21) Appl. No.: 10/735,654

(22) Filed: Dec. 16, 2003

(51) Int. Cl. G08B 1/08

(52) U.S. Cl. 340/538; 340/531; 340/539.18

(57) ABSTRACT

A household security system provides multiple ultrasonic sensors installed at different positions inside the house to monitor the surrounding interior status, wherein initially monitored statuses are used as the default values for comparing to the subsequent monitored data. If the comparing result indicates that the surrounding status has changed, a signal is transmitted to a control unit that will activate an image capturing device to collect the surrounding pictures. The captured images are transmitted to a house-owner's cell phone via a mobile telecommunication network. Based on the displayed images, the house-owner is able to determine whether the alarm should be activated or the police should be informed.

### BACKGROUND OF THE ION

1. Field of the Invention

The present invention relates to a security system, and more particularly to a security system that assists a person to easily handle all situations, moreover the security system also prevents the occurrence of false alarms.

2. Description of Related Art

Household security systems commonly use infrared or ultrasonic sensors to detect whether any moving object has entered the detecting area of the sensor. When such detection occurs, the security system will automatically generate alarming sounds or other warning signals. Such a household security system is usually activated when the occupants leave their houses.

However, a serious drawback to such security devices is the occurrence of false alarms. Especially for the families keeping pets, false alarms may possibly occur because of the pets such as cats or dogs moving around the home. In another situation, if people forget to deactivate the security device first when they enter the house, a false alarm will occur. Furthermore, the complex arrangement of the signal wires of the security sensors inside the house is another problem that bothers people.

Therefore, there is a desire to have a superior security system to obviate the aforementioned drawbacks.

### SUMMARY OF THE INVENTION

The main objective of the present invention is to provide a security device that assists the users to handle inside situations and prevents the possible occurrence of false alarms.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a first embodiment of a security system in accordance with the present invention; and

FIG. 2 is a block diagram of a second embodiment of a security system in accordance with the present invention.

### DETAILED DESCRIPTION OF THE PREFERRED EMBODIMENT

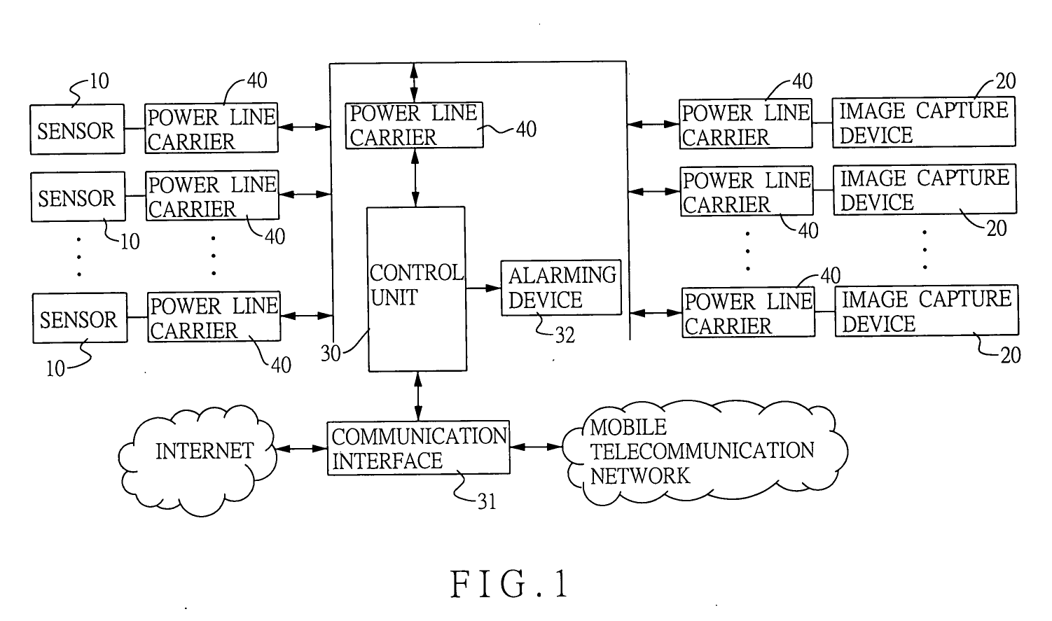

With reference to FIG. 1, a first embodiment of the security system is composed of multiple sensors (10), image capturing devices (20), a control unit (30), a communication interface (30), an alarming device (32) and other components. The multiple sensors (10) are installed at different places inside a house to monitor the indoor conditions. These sensors (10) may be chosen from infrared sensors, ultrasonic sensors, charge couple device (CCD) cameras or CMOS cameras. In the embodiment, ultrasonic sensors with memory equipped therein are adopted as an example.

The installation positions for the image capturing devices (20), which may be CCD cameras or CMOS cameras, are respectively located at the places where the sensors (10) are installed, whereby each image capture device (20) is responsible for a specific region where a respective sensor (10) monitors.

The control unit (30) is able to selectively connect to the Internet or a mobile telecommunication network through the communication interface (31) so that the captured images can be transmitted to a cell phone of the house-owner via the mobile telecommunication network, or to a police department or a security service firm via the Internet.

The alarming device (32) is activated by the control unit (30) to generate alerting signals.

The connection among the control unit (30), image capture devices (20) and sensors (10) is implemented by power lines shown in FIG. 1. It is noted that the control unit (30), each sensor (10) and each image capturing device (20) are connected to the power lines via a respective power line carrier (40). The power line carriers (40) are provided to modulate and demodulate data intended to be transmitted over these power lines so that data can be bi-directionally transmitted between the control unit (30) and the sensor (10) or image capture device (20).

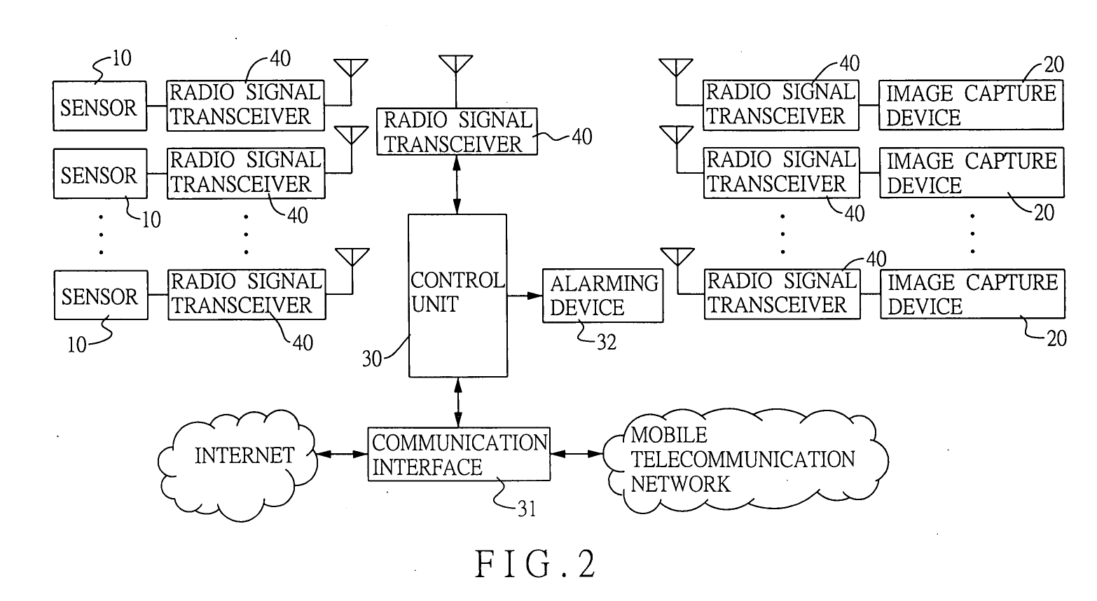

With reference to FIG. 2, the second embodiment is similar to the first embodiment of FIG. 1. The difference is that the connection among the control unit (30), image capture devices (20) and sensors (10) is implemented by wireless communication instead of the power lines. Multiple radio signal transceivers (50) are connected to the sensors (10), the image capture devices (20) and the control unit (30) for receiving and transmitting data.

When the house-owner leaves the building and activates the security system, each sensor (10) firstly records the initial environment condition as a default status and then stores the default status to the control unit (30). During the guarding period of the security system, each sensor (10) will continuously monitor the surrounding status and compare the monitored data to the default status. Once the environment status has changed,e.g. there may be moving objects in the house, the sensor (10) will output a signal to inform the control unit (30) thereby activating a corresponding image capture device (30) to take pictures. These captured pictures are further transmitted to the house-owner's cell phone through the communication interface (31) and the mobile telecommunication network.

Based on the images displayed on the cell phone, the house-owner can recognize whether any unauthorized person has entered the building. If necessary, the house-owner can directly call the police or send a command back to the control unit (30) to activate the alarm (32) and transmit an emergency notification to the security service firm via the Internet.

Occasionally, the house-owner will receive the alarm notification from the control unit (30) although no one has entered the house; such a situation may take place when there are pets inside the house. The house-owner can utilize the cell phone to send a renew command to the control unit (30) thus activating all sensors (10) to re-monitor the present inside status and updating the stored default status.

Moreover, if the situation inside the house is not able to be fully determined, the house-owner can send a command through the use of the cell phone to activate the image capture devices (20) so as to acquire more pictures.

To monitor the environmental situation, ultrasonic sensors (10) are activated to emit ultrasonic signals and receive the reflected signals. The reflected signals are converted to digital signals and then stored in the memories equipped inside the sensors (10) as the default values. The subsequent measured environment values will be compared to the default values. Once the result of the comparison shows the environment situation has changed, the sensor (10) will output a signal to inform the control unit (30). Because all the ultrasonic sensors (10) are capable of memorizing the environment situation, they can be installed at any place inside the housing without concern of the furniture arrangement.

The ultrasonic sensors may cause false alarms because of tiny changes in the environment, for example, the emitted ultrasonic signals are reflected by insects. Therefore, in order to avoid the false alarms, the threshold value for the reflected signals is adjustable. Only when the reflected signals exceed the. threshold value will the control unit (30) send captured images to the cell phone.

As mentioned above, the interconnection between the control unit (30) and the sensors (10) is implemented by power lines or wireless communication technique. When using the power lines, these power line carriers (40) modulate the signals output from the sensors (10) and transmit these modulated signals over the power lines to the control unit (30), meanwhile the signals from the control unit (30) can be demodulated. Similarly, when using the wireless technique, signals from the sensors (10) are modulated to high frequency signals and then transmitted to the control unit (30).

When the power lines are used as the signal transmission media, the sensors (10) can be directly installed into outlets fitted in the walls. On the other hand, when the signal transmission is performed by wireless communication, there is no positional limitation to the sensors (10).

Further, the image capture device (20) can be installed at any desired position, even on the outlets in the wall.

Since the CCD and CMOS cameras are capable of storing the environment situation, the aforementioned ultrasonic sensors can be replaced with these cameras as the sensors (10). However, the high resolution of the CCD or CMOS cameras may easily result in false alarms.

The emergency telephone number, such as 911 or the phone number of the security service firm, and the cell phone number of the house-owner, can be stored in the control unit (30), whereby the control unit (30) is able to dial a proper number set.

In conclusion, the functions served by the control unit (30) include:
a. communicating, transmitting and receiving signals among all elements;
b. automatically dialing the police or security service firm to deliver a warning message;
c. sending the captured images to a user's cell phone; and
d. receiving the commands from the cell phone and based on these received commands, controlling other elements.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A security system for a building, the system comprising:
at least one sensor installed inside the building to monitor environment data, wherein a memory is built inside the at least one sensor to store a default value, and the default value is applied to compare to subsequent environment data recorded by the at least one sensor;
at least one image capture device installed at a particular place near the at least one sensor to capture image data where said at least one sensor monitors the particular place;
a control unit communicating with said at least one sensor and said at least one image capture device, wherein the control unit receives signals output from the at least one sensor and controls the at least one image capture device to capture image data;
a communication interface, which serves as an interface between the control unit and the Internet or a mobile telecommunication network, whereby the captured image data is transmitted to a cell phone owned by a responsible person of the building; wherein the control unit is able to dial an emergency telephone number through the Internet to a police authority or a security service firm; and
an alarming device connected to the control unit to generate alarming signals.

2. The security system as claimed in claim 1, wherein said at least one sensor is an infrared sensor.

3. The security system as claimed in claim 1, wherein said at least one sensor is an ultrasonic sensor.

4. The security system as claimed in claim 1, wherein said at least one sensor is a CCD camera.

5. The security system as claimed in claim 1, wherein said at least one sensor is a CMOS camera.

6. The security system as claimed in claim 1, wherein said at least one image capture device is a CCD camera.

7. The security system as claimed in claim 1, wherein said at least one image capture device is a CMOS camera.

8. The security system as claimed in claim 1, wherein the at least one sensor and the at least one image capture device are connected to the control unit via power lines, and multiple power line carriers are respectively connected to the at least one sensor, the at least one image capture device and the control unit;
wherein transmitting data over the power lines are modulated or demodulated by the power line carriers.

9. The security system as claimed in claim 2, wherein the at least one sensor and the at least one image capture device are connected to the control unit via power lines, and multiple power line carriers are respectively connected to the at least one sensor, the at least one image capture device and the control unit;
wherein transmitting data over the power lines are modulated or demodulated by the power line carriers.

10. The security system as claimed in claim 3, wherein the at least one sensor and the at least one image capture device are connected to the control unit via power lines, and multiple power line carriers are respectively connected to the at least one sensor, the at least one image capture device and the control unit;
wherein transmitting data over the power lines are modulated or demodulated by the power line carriers.

11. The security system as claimed in claim 4, wherein the at least one sensor and the at least one image capture device are connected to the control unit via power lines, and multiple power line carriers are respectively connected to the at least one sensor, the at least one image capture device and the control unit;
wherein transmitting data over the power lines are modulated or demodulated by the power line carriers.

12. The security system as claimed in claim 5, wherein the at least one sensor and the at least one image capture device are connected to the control unit via power lines, and multiple power line carriers are respectively connected to the at least one sensor, the at least one image capture device and the control unit;
wherein transmitting data over the power lines are modulated or demodulated by the power line carriers.

13. The security system as claimed in claim 6, wherein the at least one sensor and the at least one image capture device are connected to the control unit via power lines, and multiple power line carriers are respectively connected to the at least one sensor, the at least one image capture device and the control unit;
wherein transmitting data over the power lines are modulated or demodulated by the power line carriers.

14. The security system as claimed in claim 7, wherein the at least one sensor and the at least one image capture device are connected to the control unit via power lines, and multiple power line carriers are respectively connected to the at least one sensor, the at least one image capture device and the control unit;
wherein transmitting data over the power lines are modulated or demodulated by the power line carriers.

15. The security system as claimed in claim 1, wherein the at least one sensor and the at least one image capture device communicate to the control unit wirelessly;
wherein multiple radio signal transceivers are respectively connected to the at least one sensor, the at least one image capture device and the control unit.

16. The security system as claimed in claim 2, wherein the at least one sensor and the at least one image capture device communicate-to the control unit wirelessly;
wherein multiple radio signal transceivers are respectively connected to the at least one sensor, the at least one image capture device and the control unit.

17. The security system as claimed in claim 3, wherein the at least one sensor and the at least one image capture device communicate to the control unit wirelessly;
wherein multiple radio signal transceivers are respectively connected to the at least one sensor, the at least one image capture device and the control unit.

18. The security system as claimed in claim 4, wherein the at least one sensor and the at least one image capture device communicate to the control unit wirelessly;
wherein multiple radio signal transceivers are respectively connected to the at least one sensor, the at least one image capture device and the control unit.

19. The security system as claimed in claim 5, wherein the at least one sensor and the at least one image capture device communicate to the control unit wirelessly;
wherein multiple radio signal transceivers are respectively connected to the at least one sensor, the at least one image capture device and the control unit.

20. The security system as claimed in claim 6, wherein the at least one sensor and the at least one image capture device communicate to the control unit wirelessly;
wherein multiple radio signal transceivers are respectively connected to the at least one sensor, the at least one image capture device and the control unit.
